(19) United States
(12) Patent Application Publication
(10) Pub. No.: US 2015/0146986 A1
(43) Pub. Date: May 28, 2015

(54) ELECTRONIC APPARATUS, METHOD AND STORAGE MEDIUM

(71) Applicant: Kabushiki Kaisha Toshiba, Tokyo (JP)

(72) Inventor: Chikashi Sugiura, Tokyo (JP)

(21) Appl. No.: 14/612,140

(22) Filed: Feb. 2, 2015

Related U.S. Application Data
(63) Continuation of application No. PCT/JP2013/057714, filed on Mar. 18, 2013.

(51) Int. Cl. G06K 9/00; G06F 3/048

(52) U.S. Cl. CPC G06K 9/00402; G06F 3/048
USPC 382/189

(57) ABSTRACT

According to one embodiment, an electronic apparatus includes a display and circuitry. The circuitry is configured to input stroke data corresponding to a handwritten stroke, display a first stroke on the display, change a display mode of the first stroke from a first display mode to a second display mode when a first-time first operation related to the first stroke is detected through the display, and change a display mode of the first stroke from the second display mode to a third display mode when a second-time first operation related to the first stroke is detected through the display following the first-time first operation.

### CROSS REFERENCE TO RELATED APPLICATIONS

This application is a Continuation application of PCT Application No. PCT/JP2013/057714, filed Mar. 18, 2013, the entire contents of which are incorporated herein by reference.

### FIELD

Embodiments described herein relate generally to processing of a handwritten document.

### BACKGROUND

In recent years, various electronic apparatuses such as tablet computers, PDAs, and smartphones have been developed. Most of these types of electronic apparatus include a touch screen display for facilitating an input operation by a user.

The user can instruct an electronic apparatus to execute a function associated with a menu or an object by touching the menu or the object displayed on a touch screen display with his or her finger or the like. The user can, for example, input a document in handwriting on the touch screen display with a stylus or his or her finger.

However, most existing electronic apparatuses including touch screen displays are consumer products specializing in operability for images, music, and other various types of media data, and may not necessarily be suitable for business, where document information must be dealt with, such as that associated with conferences, business negotiations and product development. In terms of character input, typing on a hardware keyboard is superior to handwritten input. For this reason, paper notebooks are still widely used in business. Moreover, also in terms of editing an input document, existing electronic apparatuses including touch screen displays are inconvenient.

There has been a problem that conventional electronic apparatuses have not excelled at operability when an input document is being edited.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing an outside of an electronic apparatus according to an embodiment.

FIG. 2 is an exemplary illustration showing an example of a handwritten document on a touch screen display of the electronic apparatus according to the embodiment.

FIG. 3 is an exemplary illustration for explaining stroke data (handwritten page data) corresponding to the handwritten document of FIG. 2.

FIG. 4 is an exemplary block diagram showing an example of a system configuration of the electronic apparatus according to the embodiment.

FIG. 5 is an exemplary block diagram showing an example of a function configuration of a digital note application program executed by the electronic apparatus of the embodiment.

FIG. 6 is an exemplary illustration showing a procedure of an example of editing a handwritten document executed by the electronic apparatus according to the embodiment.

FIGS. 7A, 75, 7C, and 7D illustrate a concrete example of document editing after handwriting input executed by the electronic apparatus according to the embodiment.

FIG. 8 is an exemplary illustration showing an example of character editing executed by the electronic apparatus according to the embodiment.

FIG. 9 is an exemplary illustration showing an example of table editing executed by the electronic apparatus according to the embodiment.

FIGS. 10A, 10B, and 10C illustrate a concrete example of table editing executed by the electronic apparatus according to the embodiment.

FIG. 11 is an exemplary illustration showing an example of figure editing executed by the electronic apparatus according to the embodiment.

FIG. 12 is an exemplary illustration showing an example of an undo/redo process executed by the electronic apparatus according to the embodiment.

FIG. 13 is an exemplary illustration showing another example of character editing executed by the electronic apparatus according to the embodiment.

FIGS. 14A and 14B illustrate an example of a character edit menu displayed in the other example of character editing executed by the electronic apparatus according to the embodiment.

### DETAILED DESCRIPTION

Various embodiments will be described hereinafter with reference to the accompanying drawings.

In general, according to one embodiment, an electronic apparatus includes a display and circuitry. The circuitry is configured to input stroke data corresponding to a handwritten stroke, display a first stroke on the display, change a display mode of the first stroke from a first display mode to a second display mode when a first-time first operation related to the first stroke is detected through the display, and change a display mode of the first stroke from the second display mode to a third display mode when a second-time first operation related to the first stroke is detected through the display following the first-time first operation.

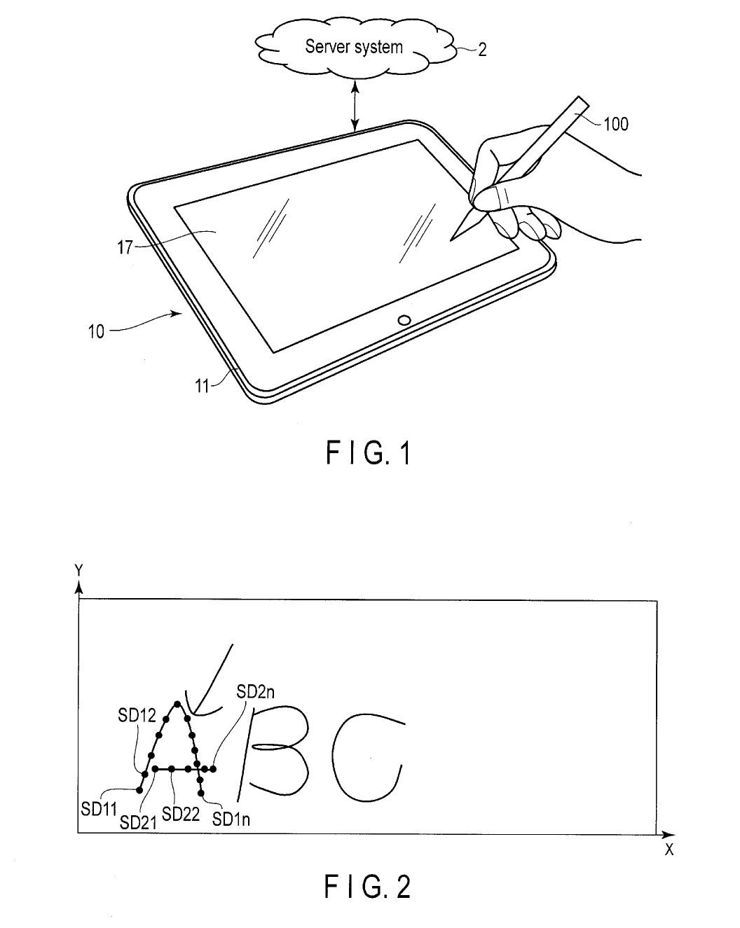

FIG. 1 is a perspective view of an external appearance of an electronic device of an embodiment. The electronic device is, for example, a stylus-based portable device having an input device on which a document is handwritten with a stylus or a finger and through which the handwritten document can be input. A handwritten document can be edited. The electronic device stores the handwritten document which is input through the input device as at least one stroke data not as a bitmap image data. The stroke indicates a time series of coordinates of sampling points indicative of a character, numeral, symbol, or figure included in the document. The handwritten document can be retrieved based on the stroke data. The retrieval processing can be performed by a server system 2 and the result of retrieving may be displayed by the electronic device. Further, the stroke data may be changed to text data including character code by performing character recognition on a stroke data group corresponding to a character, numeral, and symbol. The character recognition processing can be performed by the server system 2. The handwritten document can be stored in the form of the text data. When the stroke data is changed to a bit map image, character recognition can be performed on the bit map image.

The electronic device may be realized as a tablet computer, a notebook computer, a smartphone, a PDA or the like. A tablet computer is also called a tablet or a slate computer. The following descriptions are presented given that the electronic device is realized as a tablet computer 10 capable of handwriting input with a stylus or a finger. The tablet computer 10 includes a body 11 and a touch screen display 17.

The body 11 includes a thin box-shaped housing. The touch screen display 17 is mounted on the upper surface of the body 11 in such a manner as to be overlaid thereon.

The touch screen display 17 incorporates a flat panel display and a sensor therein. The sensor is configured to detect the contact position of a stylus or a finger on the screen of the flat panel display. The flat panel display is, for example, a liquid crystal display (LCD) device. As the sensor, for example, a capacitive touch panel, an electromagnetic induction digitizer or the like can be used. Here, both of these two kinds of sensors, namely, a digitizer and a touch panel are incorporated into the touch screen display 17.

The digitizer is provided, for example, below the screen of the flat panel display. The touch panel is provided, for example, on the screen of the flat panel display. The touch screen display 17 can detect not only a touch operation with a finger on the screen but also a touch operation with a stylus 100 on the screen. The stylus 100 may be, for example, an electromagnetic induction stylus. The user can perform a handwriting input operation on the touch screen display 17 with an external object (stylus 100 or finger). During the handwriting input operation, the locus of the movement of the external object (stylus 100 or finger), namely, the locus of a stroke input by hand is rendered in real time. In this way, the locus of each stroke is displayed on the screen. The locus of the movement of an external object while the external object is in contact with the screen corresponds to one stroke. A set of a number of strokes corresponding to a character, a figure or the like which is handwritten, namely, the set of a number of loci constitutes a handwritten document.

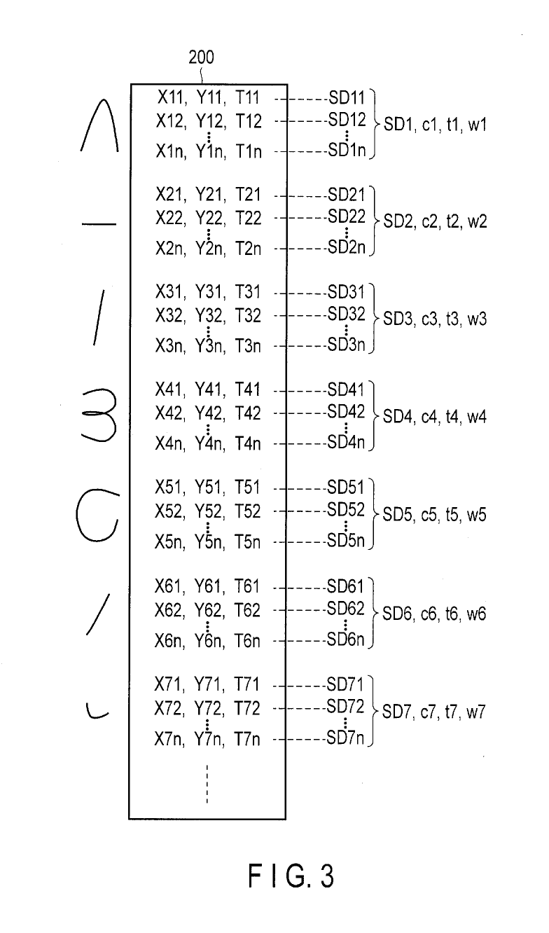

The handwritten document is stored in a storage medium not as image data but as time-series data indicative of the coordinate sequence of the locus of each stroke and the order relationship between strokes. The time-series data, which will be described later in detail with reference to FIGS. 2 and 3, includes a plurality of stroke data corresponding to respective plurality of strokes and indicative of the order in which the plurality of strokes are handwritten. In other words, the time-series data corresponds to a plurality of respective strokes. Each stroke data corresponds to a certain stroke and includes a series of coordinate data (time-series coordinates) corresponding to respective points on the locus of the stroke. The sequence of these stroke data corresponds to the order in which respective strokes are handwritten, namely, the stroke order.

The tablet computer 10 can retrieve from the storage medium any time-series data which has already been stored therein to display on the screen a handwritten document corresponding to the time-series data, namely, strokes corresponding to a plurality of stroke data indicated by the time-series data. Further, the tablet computer 10 includes an editing function. The editing function is capable of deleting or displacing any stroke, handwritten character or the like in a currently displayed handwritten document based on an editing operation by the user with an eraser tool, a selection tool and various other tools. Still further, the editing function includes an “undo” function of deleting a history of several handwriting operations and a “redo” function of reviving a deleted history.

In the present embodiment, the aforementioned time series information (handwriting) may be managed as a single page or a plurality of pages. Here, the time series information (handwriting) may be divided into several items by an area unit to fit in a single screen, and a group of the items of the time series information fit in the single screen may be stored as a single page. Or, a size of the page may be set variable. When the size is variable, it is expanded to have an area larger than the size of a single screen, and thus, a handwriting having an area larger than the screen size can be handled as a single page. When the whole page cannot be displayed in a single frame at the same time, the page may be reduced to include the whole page or a displayed part of the page may be moved by vertical and horizontal scrolls.

Since the time-series information can be managed as page data, the time-series information can be referred to as handwritten page data or mere handwritten data.

The tablet computer 10 can cooperate with a personal computer or the server system 2 on the Internet. That is, the tablet computer 10 includes a wireless communication device such as a wireless LAN and executes wireless communication with the personal computer 1. Furthermore, the tablet computer 10 may execute communication with the server system 2. The server system 2 may be a server configured to execute an online storage service or various cloud computing services. The server system 2 may be realized by one or more server computers.

The server system 2 includes a storage device such as a hard disk drive (HDD). The tablet computer 10 transmits (uploads) the time series information (handwriting) to the personal computer 1 via a network to store the time series information (handwriting) in the HDD of the server system 2. To secure the communication between the tablet computer 10 and the server system 2, the server system 2 may authorize the tablet computer 10 when initializing the communication. Here, a dialog box may be displayed on a screen of the tablet computer 10 to prompt the user to input an ID or password, or the ID of the tablet computer 10 may be transferred to the server system 2 automatically from the tablet computer 10.

Thereby, even when the storage volume inside the tablet computer 10 is low, the tablet computer 10 can handle a large number of the items of the time series information (handwriting) or a large volume of the time series information (handwriting).

Furthermore, the tablet computer 10 reads out (downloads) any optional one or more handwritings stored in the HDD of the server system 2, and displays each locus of the strokes depicted by the read-out handwriting on a screen of the display 17 of the tablet computer 10. Here, a list of thumbnails of downsized pages of the handwritings may be displayed on the screen of the display 17, or a single page selected from the thumbnails may be displayed on the screen of the display 17 in a normal size.

As can be understood from the above, in the present embodiments, the storage medium configured to store the handwriting may be a storage device in the tablet computer 10 or a storage device of the server system 2. The user of the tablet computer 10 may store a handwritten page data in storage device in the tablet computer 10 or a storage device of the server system 2.

Next, with reference to FIGS. 2 and 3, the relationship between a stroke (character, mark, figure, diagram, table, etc.,) handwritten by the user and a handwritten document will be described. FIG. 2 illustrates an example of handwritten characters handwritten with the stylus 100 or the like on the touch screen display 17.

In handwritten documents, there are many cases where, on a character, figure, etc., having already been handwritten, another character, figure, etc., is further handwritten. In FIG. 2, a case where handwritten characters “ABC” is handwritten in the order of A, B and C, and a handwritten arrow is then handwritten in immediate proximity to the handwritten character “A” is described.

The handwritten character “A” is represented by two strokes made with the stylus 100 or the like (locus in the form of “Λ” and locus in the form of “-”), that is, by two loci. The locus of the stylus 100 in the form of “Λ” made first is, for example, sampled at equal time intervals in real time, and thus time-series coordinates of the “Λ” stroke SD11, SD12, SD1n are obtained. Similarly, the locus of the stylus 100 in the form of the “-” stroke made next is sampled at equal time intervals in real time, and thus time-series coordinates of the “-” stroke SD21, SD22, SD2n are obtained.

The handwritten character “B” is presented by two strokes made with the stylus 100 or the like, namely, by two loci. The handwritten character “C” is represented by one stroke made with the stylus 100 or the like, namely, by one locus. The handwritten “arrow” is presented by two handwritten strokes made with the stylus 100 or the like, namely, by two loci.

FIG. 3 illustrates time-series data 200 corresponding to the handwritten characters of FIG. 2. The time-series data 200 includes stroke data SD1, SD2, SD7. In the time-series data 200, stroke data SD1, SD2, SD7 are listed in the stroke order, that is, in the order in which the strokes are handwritten, namely, in chronological order.

In the time-series data 200, the first two stroke data SD1 and SD2 indicate two strokes of the handwritten character “A”, respectively. The third and fourth stroke data SD3 and SD4 indicate two strokes constituting the handwritten character “B”, respectively. The fifth stroke data SD5 indicates one stroke constituting the handwritten character “C”. The sixth and seventh stroke data SD6 and SD7 indicate two strokes constituting the handwritten “arrow”, respectively.

Each stroke data includes a series of coordinate data (time-series coordinates) corresponding to one stroke, that is, a plurality of coordinates corresponding to respective points on the locus of one stroke. In each stroke data, coordinates are listed in the order in which the stroke is handwritten, namely, in chronological order. For example, as for the handwritten character “A”, stroke data SD1 includes a series of coordinate data (time-series coordinates) corresponding to the respective points on the locus of the “Λ” stroke of the handwritten character “A”, namely, coordinate data SD11, SD12, . . . , SD1n. The stroke data SD2 includes a series of coordinate data corresponding to the respective points on the locus of the “-” stroke of the handwritten character “A”, namely, coordinate data SD21, SD22, SD2n. Note that the number of coordinate data may vary from stroke data to of stroke data. That is, the locus of the stylus 100 is sampled at equal time intervals in real time, and therefore as a stroke becomes longer or a stroke is made more slowly, the number of coordinate data increases.

Each coordinate data indicates an x-coordinate and a y-coordinate corresponding to a certain point on a corresponding locus. For example, the coordinate data SD11 indicates the x-coordinate X11 and the y-coordinate Y11 of the starting point of the “A” stroke. SD1n indicates the x-coordinate X1n and the y-coordinate Y1n of the end point of the “A” stroke.

Further, each coordinate data may include timestamp data T corresponding to a point in time when a point corresponding to the coordinates is handwritten. The timestamp data T may be an absolute time (for example; year, month, date, hour, minute, and second) or a relative time represented by a time difference with regard to a reference time. An absolute time of a write start time of a stroke may added to the timestamp data T and a relative time represented by a time difference with regard to the absolute time is added to the timestamp data T of each sample point.

Since the timestamp data T is added to each sample point of the stroke data, it is possible to precisely express a time relation between the strokes. Therefore, the recognition accuracy of character recognition for a stroke group corresponding to a character is improved.

To each coordinate data, data indicative of writing pressure (Z) may be further added. The recognition accuracy of character recognition for a stroke group corresponding to a character may be further improved by referring to the pressure.

Further, the stroke data includes an attribute such as a color “c”, a pen-type “t”, or a line width “w”. An initial value of the stroke data is determined by a default value and can be changed by an editing operation.

As described in FIG. 3, the handwritten page data 200 indicates a locus of each stroke and a time relation between strokes. Therefore, it is possible to separately recognize the character “A” and the figure “arrow” as different character and figure even if a top end of the figure “arrow” is very closely to the character “A” or a top end of the figure “arrow” overlaps the character “A”.

An arbitrary one of the timestamp information T11 to T1n respectively corresponding to coordinates of the stroke data SD1 may be used as timestamp information of the stroke data SD1. An average of the timestamp information T11 to T1n may be used as the timestamp information of the stroke data SD1. An arbitrary one of the timestamp information T21 to T2n respectively corresponding to coordinates of the stroke data SD2 may be used as timestamp information of the stroke data SD2. An average of the timestamp information T21 to T2n may be used as the timestamp information of the stroke data SD2. Similarly, an arbitrary one of the timestamp information T71 to T7n respectively corresponding to coordinates of the stroke data SD7 may be used as timestamp information of the stroke data SD7. An average of the timestamp information T71 to T7n may be used as the timestamp information of the stroke data SD7.

As described above, the handwritten page data 200 indicates an order of strokes of the character by an arrangement of the stroke data SD1, SD2, . . . SD7. For example, the stroke data SD1 and SD2 indicate that the “Λ” stroke is first handwritten and the “-” stroke is the handwritten. Therefore, it is possible to separately recognize the two characters or figures with different stroke order as different characters or figures even if the two characters or figures include similar strokes.

As described above, in the embodiment, since a handwritten stroke is stored not as an image or a character recognition result, but as the time-series data 200 formed of a set of time-series stroke data, handwritten characters or figures can be treated regardless of their languages. Thus, the structure of the time-series data 200 can be shared among various countries using different languages.

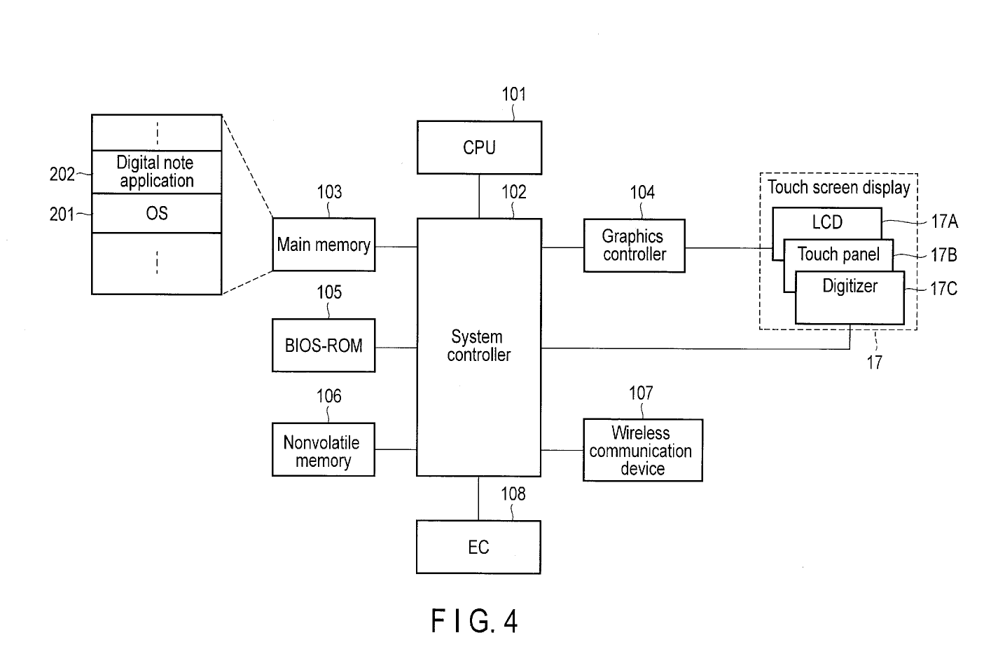

FIG. 4 illustrates a system configuration of the tablet computer 10.

The tablet computer 10 includes a CPU 101, a system controller 102, a main memory 103, a graphics controller 104, a BIOS-ROM 105, a non-volatile memory 106, a wireless communication device 107, an embedded controller (EC) 108, an acceleration sensor 109 and the like.

The CPU 101 is a processor configured to control operations of various modules in the tablet computer 10. The CPU 101 executes various computer programs loaded from a storage device, namely, the non-volatile memory 106 to the main memory 103. These programs include an operating system (OS) 201 and various application programs. The application programs include a digital note application program 202, and other application programs. The digital note application program 202 includes a function of creating and displaying the above-mentioned handwritten document, a function of editing the handwritten document, a stroke completion function and the like.

The CPU 101 executes a basic input/output system (BIOS) stored in the BIOS-ROM 105. The BIOS is a program for hardware control.

The system controller 102 is a device configured to connect a local bus of the CPU 101 and various other components. The system controller 102 includes a built-in memory controller configured to perform access control of the main memory 103. Further, the system controller 102 includes a function of performing communication with the graphics controller 104 via a serial bus conforming to the PCI Express standard or the like.

The graphics controller 104 is a display controller configured to control an LCD 17A used as a display monitor of the tablet computer 10. A display signal generated by the graphics controller 104 is transmitted to the LCD 17A. The LCD 17A displays a screen image based on the display signal. The LCD 17A is provided with a touch panel 17B and a digitizer 17C thereon. The touch panel 17B is a capacitive pointing device for performing input on the screen of the LCD 17A. A contact position touched with a finger on the screen, the movement of the contact position and the like are detected by the touch panel 17B. The digitizer 17C is an electromagnetic induction pointing device for performing input on the screen of the LCD 17A. A contact position touched with the stylus 100 on the screen, the movement of the contact position and the like are detected by the digitizer 17C.

The wireless communication device 107 is a device configured to establish wireless communication such as wireless LAN or 3G cellular. The tablet computer 10 is connected to the server system 2 by the wireless communication device 107 via the Internet or the like. The EC 108 is a single-chip microcomputer including an embedded controller for power control. The EC 108 includes a function of powering on or powering off the tablet computer 10 based on an operation of a power button by the user.

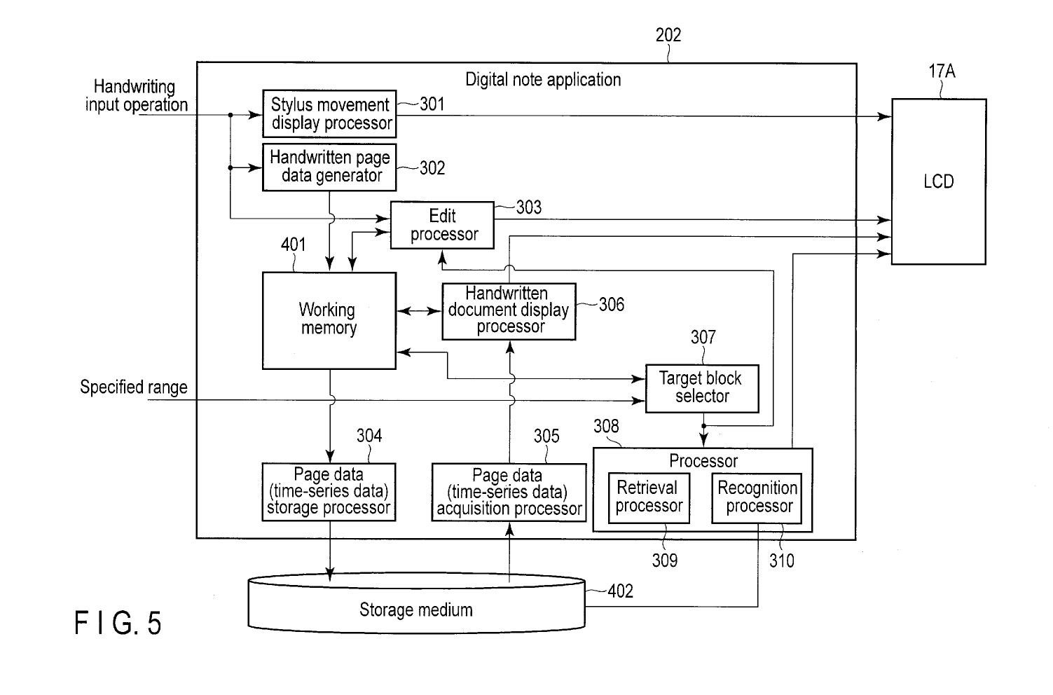

Next, a functional configuration of the digital note application program 202 will be described with reference to FIG. 5.

The digital note application program 202 includes a stylus movement display processor 301, a handwritten page data generator 302, an edit processor 303, a page data storage processor 304, a page data acquisition processor 305, a handwritten document display processor 306, a target block selector 307, a processor 308, etc.

The digital note application program 202 performs preparation, display, edit, character recognition, etc., of handwritten page data by using stroke data input on the touch screen display 17. The touch screen display 17 is configured to detect occurrence of events such as touch, move (slide) and release. The touch event is an event indicating that an external object such as the stylus 100 or the finger has touched the screen. The move (slide) event is an event indicating that a touch position has been moved while the external object touches the screen. The release event is an event indicating that the external object has been released from the screen.

The stylus movement display processor 301 and the handwritten page data generator 302 receive the touch or move (slide) event generated by the touch screen display 17, thereby detecting a handwriting input operation. The touch event includes a coordinate of a touch position. The move (slide) event also includes a coordinate of the touch position which has been moved. Thus, the stylus movement display processor 301 and the handwritten page data generator 302 can receive a coordinate sequence corresponding to a movement of the touch position from the touch screen display 17.

The stylus movement display processor 301 receives a coordinate sequence from the touch screen display 17, and displays a movement of each stroke which is handwritten by a handwriting input operation with the stylus 100, etc., on the screen of the LCD 17A in the touch screen display 17 on the basis of the coordinate sequence. The stylus movement display processor 301 draws a movement of the stylus 100 taken while the stylus 100 touches the screen, that is, a movement of each stroke, on the screen of the LCD 17A.

The handwritten page data generator 302 receives the above-described coordinate sequence output from the touch screen display 17, and generates the above-described handwritten page data having such a structure as has been described with reference to FIG. 3 on the basis of the coordinate sequence. In this case, the handwritten page data, that is, a coordinate corresponding to each point of a stroke and timestamp data, may be temporarily stored in a working memory 401.

The page data storage processor 304 stores generated handwritten page data in a storage medium 402. The storage medium 402 is a local database for storing handwritten page data. The storage medium 402 may be provided in the server system 2.

The page data acquisition processor 305 reads arbitrary handwritten page data that has been already stored from the storage medium 402. The read handwritten page data is transmitted to the handwritten document display processor 306. The handwritten document display processor 306 analyzes the handwritten page data, and displays handwriting which is a movement of each stroke indicated by each stoke data in the handwritten page data, as a handwritten page on the screen with a color, a pen-type and a thickness specified by attribute data on the basis of results of the analysis.

The edit processor 303 executes a process for editing a handwritten page that is being currently displayed. That is, the edit processor 303 changes an attribute of a character of stroke data of the handwritten page that is being currently displayed, retrieves a character, shapes a line, colors a partial region in a table, performs an image process for a handwritten figure, retrieves a figure similar to the handwritten figure and replaces the handwritten figure with a retrieved figure, and performs deletion, copying, movement, deletion of histories of several handwriting operations (undo function), restoration of the deleted histories (redo function), etc., in accordance with an edit operation performed by the user on the touch screen display 17. Moreover, to make handwritten page data that is being currently displayed reflect the results of editing, the edit processor 303 updates the handwritten page data.

In addition to the edit function, the user can delete an arbitrary stroke in displayed strokes by using an eraser tool, etc. The user can specify an arbitrary portion in handwritten page data that is being currently displayed by using a range specification tool for enclosing the arbitrary portion on the screen with a circle or a square. On the basis of a range on the screen specified by a range specification operation, handwritten page data to be processed, that is, a group of stroke data to be processed is selected by the target block selector 307. That is, the target block selector 307 selects a group of stroke data to be processed from a group of first stroke data corresponding to respective strokes within the specified range.

For example, the target block selector 307 extracts the group of first stroke data corresponding to the respective strokes within the specified range from the displayed handwritten page data, and determines the stroke data in the group of first stroke data except second stroke data which are discontinuous with the other stroke data in the group of first stroke data as the group of stroke data to be processed.

The processor 308 can execute various processes, for example, a handwriting retrieval process and a character recognition process, for handwritten page data to be processed. The processor 308 includes a retrieval processor 309 and a recognition processor 310.

The retrieval processor 309 searches handwritten page data which have been already stored in the storage medium 402, and retrieves a specific group of stroke data (specific handwritten character string, etc.) in the handwritten page data. The retrieval processor 309 includes a designation module configured to designate the specific group of stroke data as a retrieval key, that is, a retrieval query. The retrieval processor 309 retrieves a group of stroke data having a movement of a stroke whose similarity to a movement of a stroke corresponding to the specific group of stroke data is greater than or equal to a reference value, reads handwritten page data including the retrieved group of stroke data from the storage medium 402, and displays the handwritten page data on the screen of the LCD 17A, such that the movement corresponding to the retrieved group of stroke data is visible.

As the specific group of stroke data designated as the retrieval key, not only a specific handwritten character, a specific handwritten character string, and a specific handwritten symbol, but a specific handwritten figure, etc., can be used. For example, one or more strokes constituting a handwritten object (a handwritten character, a handwritten symbol, or a handwritten figure) handwritten on the touch screen display 17 can be used as the retrieval key.

The retrieval processor 309 retrieves a handwritten page including a stroke having a similar feature to a feature of one or more strokes as the retrieval key from the storage medium 402. The feature of each stroke is, for example, a writing direction, a shape, an inclination, etc. In this case, a hit handwritten page including a handwritten character whose similarity to a stroke of a handwritten character as the retrieval key is greater than or equal to a reference value is retrieved from the storage medium 402. To calculate a similarity between handwritten characters, various methods can be used. For example, a coordinate string of each stroke may be handled as a vector. In this case, to calculate a similarity between vectors to be compared, the inner product between the vectors to be compared may be calculated as a similarity between the vectors to be compared. In another example, with a movement of each stroke handled as an image, the size of the area of a portion where images of movements to be compared overlap the most may be calculated as the above-described similarity. Further, an arbitrary device to reduce calculation throughput may be adopted. A dynamic programming (DP) matching may be used as a method for calculating a similarity between handwritten characters.

In this manner, because not a group of codes indicative of a character string but stroke data is used as the retrieval key, retrieval can be conducted independently of language.

The retrieval process can be performed not only for handwritten page data in the storage medium 402 but for handwritten page data stored in the storage medium of the server system 2. In this case, the retrieval processor 309 transmits a retrieval request including one or more stroke data corresponding to one or more strokes to be used as the retrieval key to the server system 2. The sever system 2 retrieves a hit handwritten page having a similar feature to a feature of the one or more stroke data from the storage medium 402, and transmits the hit handwritten page to the tablet computer 10.

The above-described designation module in the retrieval processor 309 may display a retrieval key input region for handwriting a character string or a figure to be retrieved on the screen. A character string, etc., handwritten on the retrieval key input region by the user is used as a retrieval query.

Alternatively, the above-described target block selector 307 may be used as the designation module. In this case, the target block selector 307 can select a specific group of stroke data in handwritten page data that is being displayed as a character string or a figure to be retrieved on the basis of a range specification operation executed by the user. The user may specify a range to enclose some character strings in a page that is being displayed, or may newly handwrite a character string for a retrieval query in a margin of the page that is being displayed and specify a range to enclose the character string for the retrieval query.

For example, the user can specify a range by enclosing a part of the page that is being displayed in a handwritten circle. Alternatively, the user may set the digital note application program 202 in a select mode with a menu prepared in advance, and then trace the part of the page that is being displayed with the stylus 100.

In this manner, in the embodiment, a handwritten character similar to a feature of a certain handwritten character selected as a retrieval query can be retrieved from handwritten pages that have been already stored. Thus, a handwritten page intended by the user can be easily retrieved from a number of pages prepared and stored previously.

Unlike text retrieval, the handwriting retrieval of the embodiment does not require character recognition. Thus, since the handwriting retrieval does not depend on the language, a handwritten page in any language can be retrieved. Furthermore, a figure, etc., can be used as a retrieval query for the handwriting retrieval, and, a non-linguistic symbol, a symbol, etc., can be used as the retrieval query for the handwriting retrieval.

The recognition processor 310 executes character recognition for handwritten page data that is being displayed. The recognition processor 310 matches one or more stroke data (stroke data group) corresponding to a character, a number, a symbol, etc., to be recognized with dictionary stroke data (stroke data group) of the character, the number, the symbol, etc., and converts each handwritten character, number, symbol, etc., into a character code. The dictionary stroke data may be any data indicating correspondence between each character, number, symbol, etc., and the one or more stroke data, and is, for example, identification data of each character, number, symbol, etc., and one or more stroke data associated therewith. In grouping, one or more stroke data indicated by handwritten page data to be recognized are grouped, such that stroke data corresponding to strokes which are in proximity to each other and are continuously handwritten, respectively, are classified in the same block. Because the handwritten page data includes the order of writing and timestamp data, and may include writing pressure data, in addition to handwriting (bitmap image), the accuracy of recognition can be improved by using these items.

In this manner, a character code per group corresponding to each character can be obtained from handwritten page data. When character codes are arranged on the basis of the arrangement of groups, text data of handwritten page data of a single page is obtained, and both the character codes and the text data are associated with each other and are stored in the storage medium 402.

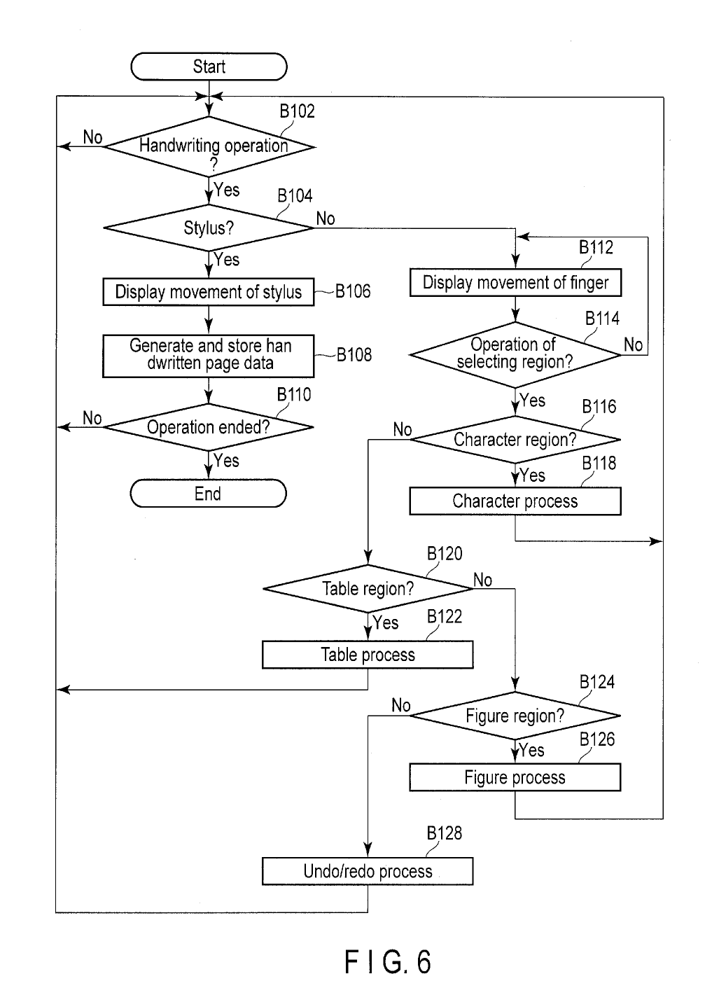

Hereinafter, a concrete operation example of the embodiment will be described. First, an example of a procedure of editing a handwritten document executed by the digital note application program 202 will be described with reference to a flowchart shown in FIG. 6.

When the user performs handwriting input operation with the stylus 100 or the finger, the touch or move event occurs. In block B102, on the basis of the event, it is determined whether a handwriting operation exists. If it is detected that a handwriting operation exists (Yes in block B102), it is determined whether the handwriting operation has been executed with the stylus 100 or not in block B104. In the embodiment, those handwritten with the stylus 100 are regarded as a document, and those handwritten with the finger are regarded as not a document but an input of an instruction of an edit operation. Thus, an instruction to edit a document which has just been handwritten and is being currently displayed can be given by executing a predetermined handwriting input operation with the finger immediately after handwriting the document with the stylus 100. Thus, input and editing can be executed by a series of operations. In block B104, if the touch panel 17B detects the touch or move event, it is determined that the handwriting operation has been executed with the finger; and if the digitizer 17C detects the event, it is determined that the handwriting operation has been executed with the stylus 100.

If it is determined that the handwriting operation has been executed with the stylus 100 in block B104, a detected movement of the stylus 100, that is, a handwritten document, is displayed on the touch screen display 17. Moreover, the above-described stroke data as shown in FIG. 3 is generated on the basis of a coordinate string corresponding to the detected movement of the stylus 100 (handwritten stroke), and an assembly of stroke data are temporarily stored in the working memory 401 as handwritten page data (block B108). A document to be displayed is based on one or more strokes.

In block B110, it is determined whether the handwriting operation has been ended. The end of the handwriting operation can be detected on the basis of occurrence of the release event. If the handwriting operation has been ended, the operation ends, and if it has not been ended, the operation returns to block B102.

If it is determined in block B104 that the handwriting operation has been executed with the finger, a detected movement of the finger is displayed on the display in block B112. Since those handwritten with the finger are regarded as an input of an instruction of an edit operation, stroke data is not generated from the movement of the finger. Unlike in inputting a handwritten document, a line traced with the finger may not be kept being displayed but may be gradually deleted as it becomes older. Further, only a touched portion may be highlighted.

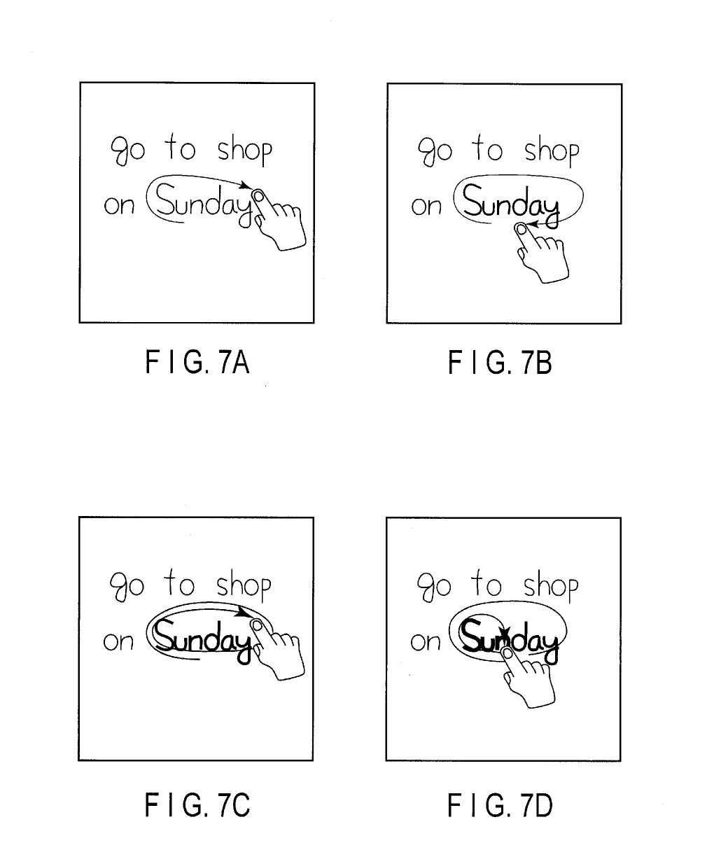

In block B114, it is determined whether the handwriting operation is a gesture operation of selecting a certain region. The certain region is a region to be edited in a handwritten document. An example of selection operation is, as shown in FIG. 7A, an operation of enclosing the region to be edited including a character string “Sunday” in the document. Even if an end point does not precisely accord with a start point, as long as the end point has returned to the proximity of the predetermined start point as shown in FIG. 7B, it is determined that the region to be edited has been enclosed. Other examples of the selection operation include a spread operation of placing two fingers on the center of the region to be edited and spreading the fingers until the entire region to be edited is included, a pinch operation, a tap operation, a double-tap operation, a flick operation, a slide operation, a swipe operation, and a simultaneous tap operation at a plurality of points. Once a tap operation is executed, a predetermined circular region or elliptical region is selected, and the circular region or elliptical region expands entirely, or horizontally or vertically, by repeating the tap operation, whereby the entire region to be edited can be included.

If it is determined that the region to be edited has been selected in block B114, it is determined whether the region to be edited is a region including a character, a region including a table, a region including a figure/illustration, or none of these, that is, an empty region, in blocks B116, B120 and B124. In block B116, if the region includes a line (referring to time information of stroke data, if a predetermined time period exists between the times of one stroke and another stroke, that is, if the stylus is away from the touch screen display 17 for a predetermined time period or more, it can be determined that the line is included), it is determined that a document in the region to be edited is a character. If the region does not include a line, it is determined that the document in the region to be edited is a noncharacter. If it is determined that the document is a character, character editing (for example, changing the color, type or thickness of a character, display of a result of retrieval carried out using the character, etc.) is executed in block B118. In block B120, if vertical and horizontal lines having a predetermined length or more cross in the region, it is determined that the document in the region to be edited is a table. If it is determined that the document is a table, table editing (for example, recognition of a character, shaping of a line, coloring of a partial region, etc.) is executed in block B122. In block B124, if stroke data in the region to be edited is neither a character nor a table, it is determined that the document in the region is a figure/illustration; and if stroke data does not exist in the region to be edited, it is determined that the region is an empty region. If it is determined that the document is a figure/illustration, figure/illustration editing (for example, an image process for a figure, etc.) is executed in block B126; and if it determined that the region is an empty region, an undo/redo process is executed in block B128.

Depending on a result of determination of the region to be edited, any of the character process of block B118, the table process of block B122, the figure/illustration process of block B126, and the undo/redo process of block B128 is executed. When each process ends, it is determined whether a handwriting operation exists in block B102.

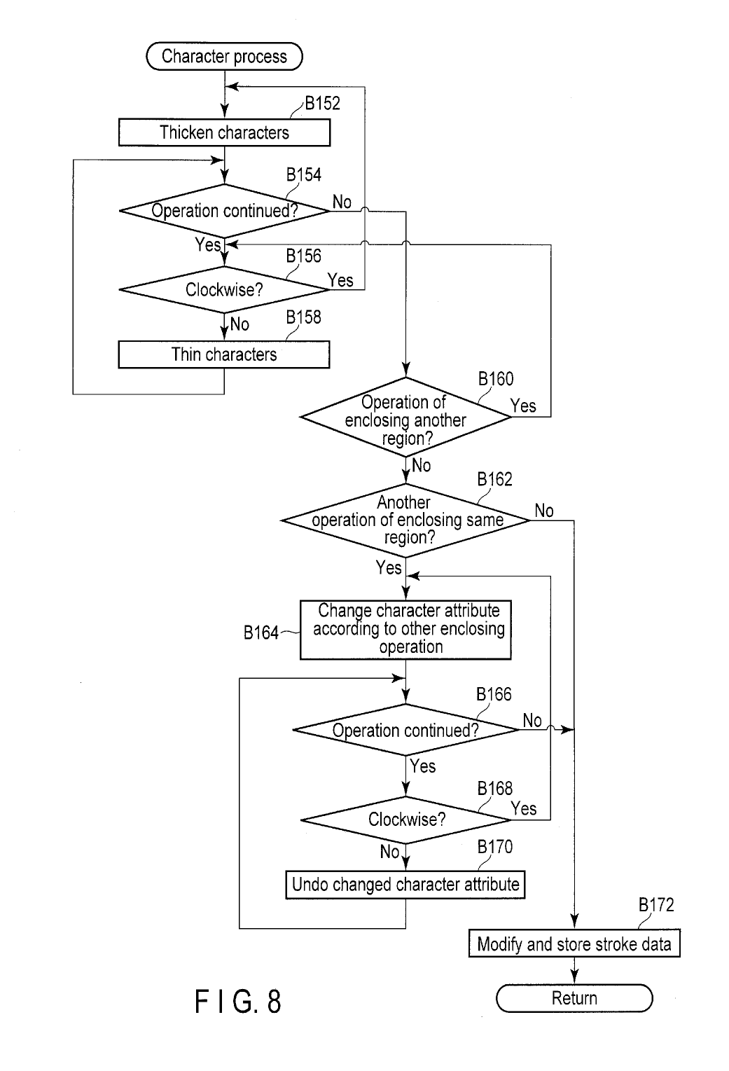

FIG. 8 shows an example of the character process of block B118. If an operation of selecting a region to be edited is detected in block B114 and it is detected that the region to be edited is a character region in block B116, the display mode of strokes of the region to be edited is changed from a first display mode to a second display mode. Here, a line width of characters in the region to be edited is thickened by one step in block B152 (see FIG. 7B). That is, if the region to be edited is enclosed once, the characters become thicker.

Next, when a second-time operation is detected, the display mode of strokes in the region to be edited is changed from the second display mode to a third display mode. Here, when the same operation is continued, the characters become further thicker. For example, when an operation of enclosing the region to be edited is executed twice, the characters become further thicker by one step, and as the number of times the region is enclosed increases, the characters become thicker accordingly. It should be noted that an upper limit may be set for the line width of the characters, because if the characters become thicker unlimitedly, they get crushed and become illegible. In this case, when the characters become thicker to the upper limit, the thickness does not vary however many times the region is enclosed. If the upper limit is reached, the user may be notified by blinking the characters, giving an alarm (a sound or a message), or the like. The upper limit of thickness is, for example, one fifth the height of a character.

In contrast, if the same operation has been continued in the opposite direction, the line width of the characters becomes thinner. Here, it is assumed that the region selection operation of block B114 is an operation of enclosing the region to be edited clockwise substantially once. Thus, a clockwise operation corresponds to an operation of thickening the characters, and an anticlockwise operation corresponds to an operation of thinning the characters. The directions of rotation may be reversed.

In the above description, it is assumed that the region selection operation of block B114 is an operation of enclosing the region to be edited clockwise substantially once. Thus, a first-time operation of changing the line width (that is, the region selection operation) and second-time and subsequent operations of changing the line width are the same clockwise or anticlockwise operations. However, as long as the second and subsequent operations of changing the line width are the same operations, the first-time operation of changing the line width and the second and subsequent operations of changing the line width may not be the same operations. That is, the first-time operation of changing the line width may be a spread operation or a tap operation, and the second-time and subsequent operations of changing the line width may be operations of enclosing the region.

The specification of a region to be edited has been described to require that the finger move around the region substantially once to substantially enclose the region. However, the second-time and subsequent operations of changing the line width may not necessarily enclose the region once and may be a part of an enclosing operation (for example, a movement of movement over a predetermined length or over a predetermined time). That is, if a fraction of one enclosing operation is handwritten, it is determined that the enclosing operation has been continued. Therefore, an operation of enclosing the region need not be performed many times to change the line width gradually, and rapid operation can be achieved.

In block B154, it is determined whether a gesture operation of enclosing the region has been continued. As described above, this determination may be based on detection of a movement over a predetermined length or over a predetermined time. If it is determined that the enclosing operation has been continued, it is determined whether the continued enclosing operation is clockwise in block B156. If the continued enclosing operation is clockwise, the process returns to block B152, and the line width of the characters in the region to be edited becomes further thicker by one step (see FIG. 7C). If the continued enclosing operation is anticlockwise, the line width of the characters in the region to be edited becomes thinner by one step in block B158. Then, the determination of whether the enclosing operation has been continued of block B154 is executed. As the number of times of anticlockwise enclosing operations increases, the line width becomes thinner accordingly, and may become thinner than it was originally. Also in the case of thinning the characters, a lower limit may be set for the line width of the characters, because if the line width becomes thinner unlimitedly, the line fades and becomes illegible. In this case, when the line width becomes thinner to the lower limit, the thickness does not vary however many times the region is enclosed. Also when the lower limit is reached, the user may be notified by blinking the characters, giving an alarm (a sound or a message), or the like.

In the determination of the continuity of an enclosing operation of block B154, even if exactly the same region as that of a first-time enclosing operation is not enclosed but a similar small region is enclosed, it is determined that the operation has been continued. Therefore, it suffices, only if a region which is inside the region to be edited and is similar to the region to be edited is enclosed in the second-time and subsequent operations, while if the region to be edited includes a number of characters, it is hard for the user to enclose a region having exactly the same area.

If it is determined that the enclosing operation has been stopped in block B154, it is determined whether an operation of enclosing another region has been executed in block B160. The other region may be a region including a completely different character string, etc. (for example, a region including “shop” in the example of FIG. 7A), or may be a small region including a part of the characters in the region to be edited (for example, a region including “Sun” in “Sunday” as shown in FIG. 7D). If it is determined that the operation of enclosing another region has been executed, the process returns to block B156, and the same process as the process of changing the line width of the characters executed for the region to be edited in blocks B152, B154, B156 and B158 is executed for the other region. Here, the operation of enclosing the other region is also executed clockwise.

If it is determined that the operation of enclosing another region has not been executed in block B160, it is determined whether another type of enclosing operation is executed for the same region (the region to be edited) in block B162. As shown in FIG. 7A, if the operation of enclosing the region to be selected is an operation of enclosing the region substantially in an ellipse, examples of the other type of enclosing operation include an operation of enclosing the region in a rectangle, a rhombus, a trapezoid, a triangle, etc. If it is determined that the other type of enclosing operation has been executed for the region to be edited, a character attribute according to the type of the other enclosing operation is changed by one step in one direction in block B164. For example, if the region is enclosed in a rectangle, a color is changed; if the region is enclosed in a rhombus, a stylus type is changed; and if the region is enclosed in a triangle, a size is changed. Although a character attribute which is changed when the region to be edited is first enclosed has been described as the line width, this attribute can be arbitrarily set and can be switched at the user's convenience.

In block B166, it is determined whether the enclosing operation has been continued. If it is determined that the enclosing operation has been continued, it is determined whether the enclosing operation is clockwise in block B168. If the continued enclosing operation is clockwise, the process returns to block B164, and a character attribute according to the type of the enclosing operation is further changed by one step. If the continued enclosing operation is anticlockwise, a character attribute according to the type of the enclosing operation is changed by one step in the opposite direction in block B170. Then, the determination of the continuity of the enclosing operation in block B166 is executed.

If it is determined that the enclosing operation has been stopped in block B166, attribute data (line width, color, or stylus type) accompanying stroke data in the region to be edited is modified and stored in block B172.

A character attribute to be changed has been described as being switched according to the type of enclosing operation (for example, enclosing in an ellipse, enclosing in a rectangle, etc.), but may be switched by continuing the same type of operation. For example, if the same operation has been continued and the thickness has become thicker to the upper limit, other attributes (for example, color, type, etc.) may be successively changed by one step by further continuing the same operation.

In this manner, if a region including a character is enclosed by the finger after handwriting is input with the stylus, a predetermined attribute of the character in the region is changed. Then, by continuing the same operation in the same direction, the degree of the change is made larger. The degree of the change is made smaller by executing the same operation in the opposite direction. Thus, for example, one attribute of the character can be continuously changed by continuing the same type of operation of enclosing the region, and the attribute of the character can be changed in the opposite direction by reversing the direction of the same type of operation. Thus, a character attribute can be changed by an intuitive operation. Moreover, if the user wants to switch a character attribute to be changed, other attributes also can be continuously changed by switching the type of operation.

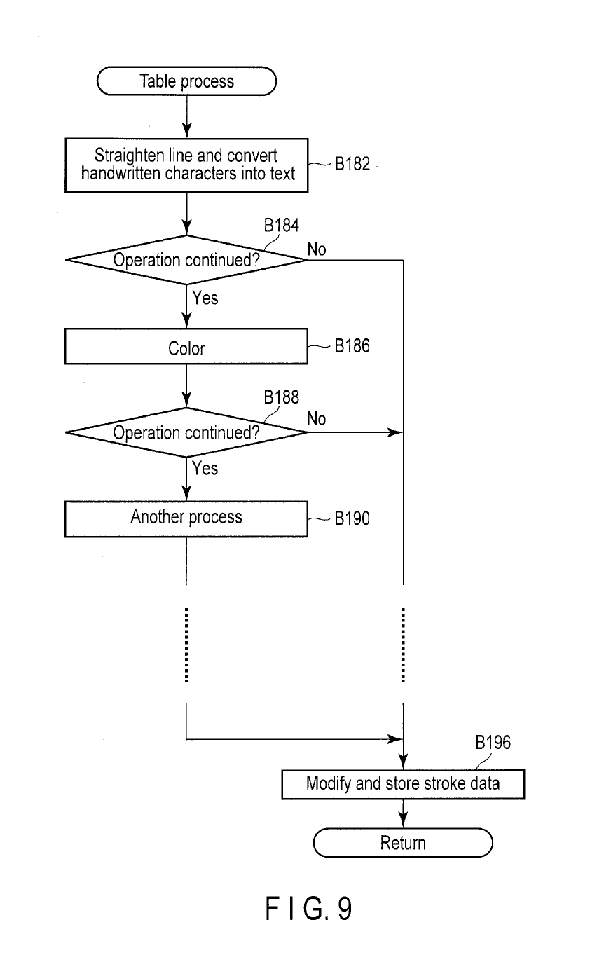

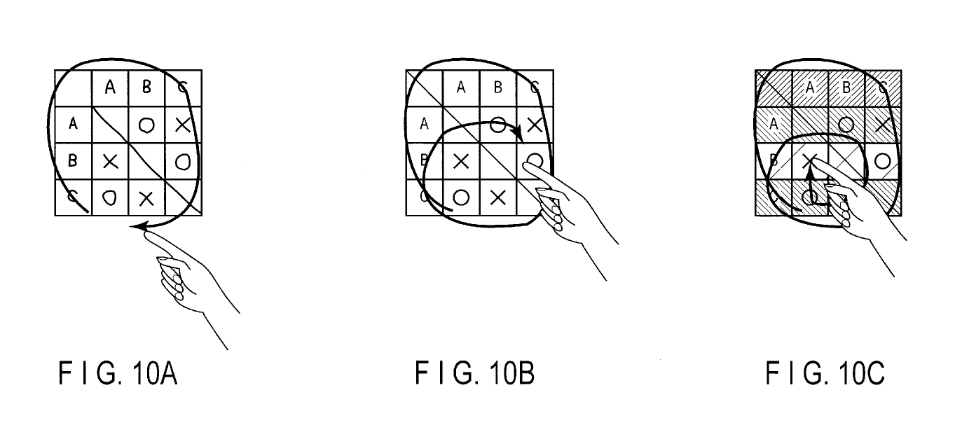

FIG. 9 shows an example of the table process of block B122. In the character process, since there are a plurality of character attributes to be changed, the character attributes are switched depending on the way the region is enclosed, and the degree of changing an attribute is adjusted according to the number of times or the duration of operations. In the table process, there is no idea of the degree of change, and only the type of change is concerned. Thus, predetermined edit processes are successively executed while the operation is continuously executed. First, in block B182, a line in the table is straightened, and handwritten characters are converted into text by an OCR process or a character recognition process (see FIGS. 10A and 10B). In block B184, it is determined whether the enclosing operation has been continued. If it is determined that the enclosing operation has been continued, each cell of the table is colored in block B186. The coloring improves the viewability of the table (see FIG. 10C). In the following, similarly, it is determined whether the enclosing operation has been continued in block B188, and if it is determined that the enclosing operation has been continued, another table edit process (for example, shaping of the table) is executed in block B190. If it is detected that the enclosing operation has been stopped, stroke data in the region to be edited is modified and stored in block B196.

Although not shown in the figures, also in this case, a change may be undone by changing the direction of the enclosing operation, that is, executing the enclosing operation anticlockwise. Further, the order of the table edit processes of blocks B182, B186, and B190 can be arbitrarily set, and can be changed at the user's convenience.

In this manner, if a region including a table is enclosed after handwriting is input with the stylus, various table edit processes are successively executed by continuously executing the enclosing operation. Thus, the table can be variously edited by continuously executing the same type of operation of enclosing the region.

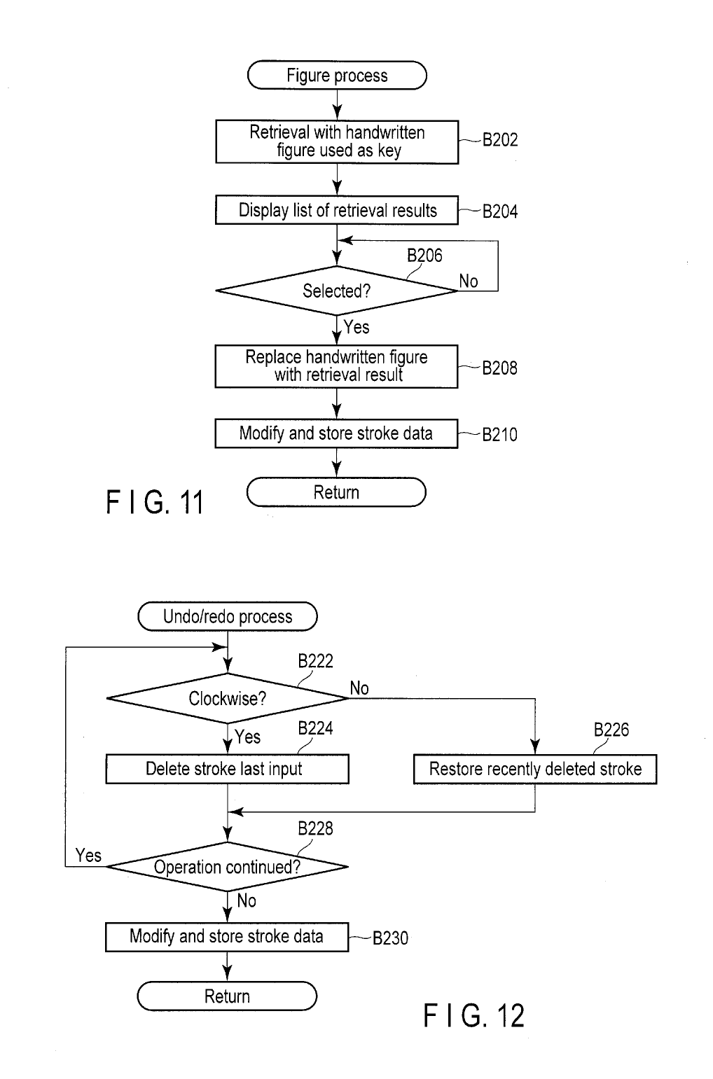

FIG. 11 shows an example of the figure process of block B126. In block B202, retrieval is executed with stroke data corresponding to a handwritten figure in the region to be edited used as a retrieval key, that is, a retrieval query. If a figure whose similarity to the retrieval key is greater than or equal to a reference value is detected, a list of retrieval results is displayed in block B204. When any of the retrieval results (figures) is selected in block B206, a handwritten figure is replaced with a retrieval result in block B208, and the handwritten figure is shaped. In block B210, stroke data in the region to be edited is modified and stored.

In this manner, if a region including a figure is enclosed after handwriting is input with the stylus, a predetermined series of figure edit processes is successively executed. Thus, the figure can be edited only by the operation of enclosing the region.

FIG. 12 shows an example of the undo/redo process of block B128. In block B222, it is determined whether the direction of the operation of enclosing an empty region is clockwise. If the direction is clockwise, one item of stroke data which has been last input is deleted in block B224 (undo). If the direction is anticlockwise, one item of stroke data which has been recently deleted is restored in block B226 (redo). In block B228 after block B224 or block B226, it is determined whether the operation of enclosing the empty region has been continued. If it is determined that the enclosing operation has been continued, the process returns to block B222, where it is determined whether the enclosing operation is clockwise. If the operation has been stopped, stroke data is modified and stored in block B230.

In this manner, when the empty region which is not a character, a table, or a figure is enclosed after handwriting is input with the stylus, the undo process is executed if the enclosing operation is clockwise, and the redo process is executed if the enclosing operation is anticlockwise. If the enclosing operation is continued, the undo/redo process is repeated. The undo/redo process can thereby be repeated by an intuitive operation of continuously executing the same type of operation of enclosing the empty region.

It should be noted that if documents are closely written on the display, an empty region may not exist. In this case, irrespective of a handwriting position, a specific enclosing operation may be regarded as an instruction to execute the undo/redo process. For example, if the same point is enclosed round and round by simultaneous touch with two fingers, an instruction to execute the undo/redo process is given in accordance with the enclosing direction. Stroke data corresponding to a handwritten stroke is input, and one or more first strokes are displayed on the display. Here, if a first-time first operation for the one or more strokes is detected through the display, the display mode of the one or more first strokes is changed from the first display mode to the second display mode. If a second-time first operation for the one or more first strokes is detected through the display following the first-time first operation, the display mode of the one or more first strokes is changed from the second display mode to the third display mode.

If the first-time first operation for the one or more strokes is detected through the display, the display mode of the one or more first strokes is changed to the second display mode varying according to the type of the one or more first strokes.

The type of the one or more first strokes includes at least one of a character, a noncharacter, a figure, and a table.

The first display mode is changed to the second display mode by changing a first attribute of attributes of the one or more first strokes.

The second display mode is changed to the third display mode by changing a second attribute of the attributes of the one or more first strokes.

The attributes of the one or more first strokes include at least one of a thickness, a color and a type of a line.

The first-time first operation and the second-time first operation are gesture operations of the same type which are executable on the display.

The first-time first operation and the second-time first operation are operations of enclosing a region on the display which is in proximity to a display region of the one or more first strokes on the display.

If the second-time first operation for the one or more first strokes is detected through the display following the first-time first operation, the display mode of the one or more first strokes is gradually changed from the second display mode to the third display mode in accordance with the execution state of the second-time first operation during a period between the time at which the second-time first operation starts and the time at which the second-time first operation ends.

If a second operation for the one or more first strokes in the opposite direction to that of the first operation is detected through the display following the first-time first operation, the display mode of the one or more first strokes is changed from the second display mode to the first display mode.

The first-time first operation and the second-time first operation are any operations of tapping, double-tapping, flicking, sliding, swiping, spreading, pinching, and simultaneous tapping at points in a region on the display which is in proximity to a display region of the one or more first strokes on the display. In the case where the type of the one or more first strokes is a table, at least one of the changing from the first display mode to the second display mode and the changing from the second display mode to the third display mode is recognition of a character included in the one or more first strokes, shaping of a line included in the one or more first strokes, or coloring of a partial region of the table related to the one or more first strokes.

In the case where the type of the one or more first strokes is a character, a result of retrieval carried out using a character corresponding to the one or more first strokes is displayed if the first-time first operation or the second-time first operation is detected.

In the case where the type of the one or more first strokes is a figure, an image process for the figure is executed if the figure is included in a region specified by the first-time first operation or the second-time first operation.

In the above description, when the region to be edited is specified, a process determined by default is executed on the basis of the type of contents included in the region, and when the operation is continued, the degree of the process varies. To execute different processes, it has been necessary to execute different operations for the same region. However, different processes can also be executed by displaying an operation menu which is a list of the different processes and selecting a process therefrom.

Next, examples of displaying an operation menu based on the type of contents included in the region when the region to be edited is specified will be described as other examples of the character process of block B118, the table process of block B122, and the figure process of block B126.

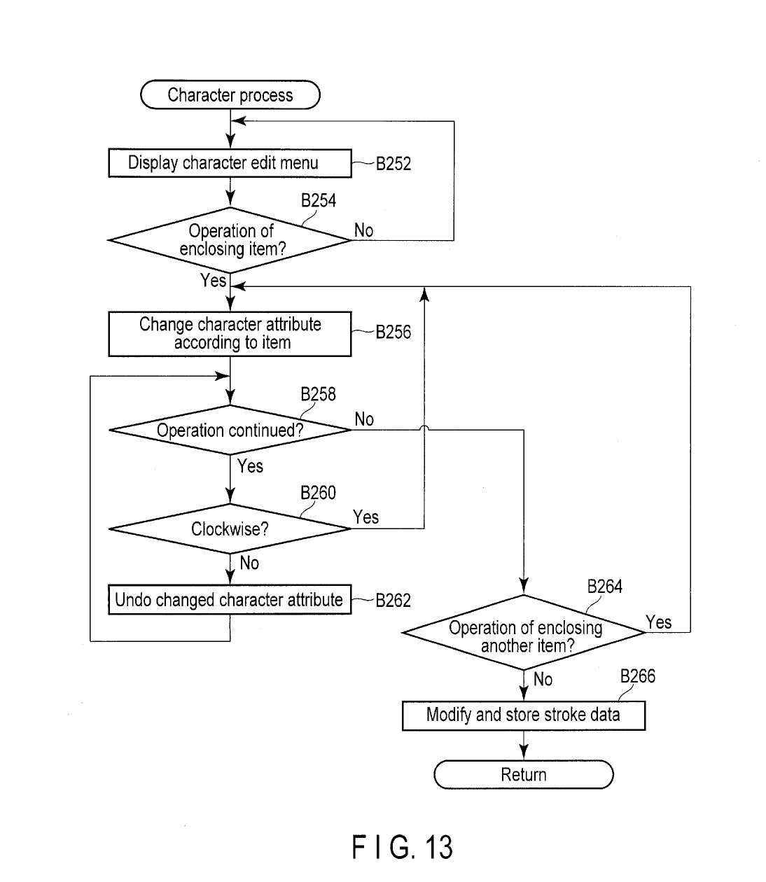

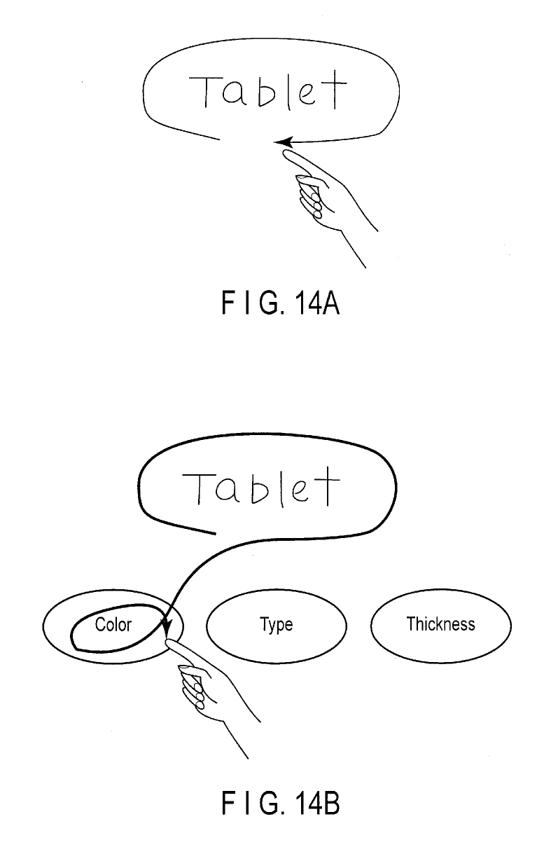

FIG. 13 shows the other example of the character process of block B118. First, a menu for character editing is displayed in block B252. FIGS. 14A and 14B show an example of the menu. As shown in FIG. 14A, when a region to be edited including a character string “Tablet” in the document is enclosed, the operation menu including the items “color” “stylus type”, and “thickness” is displayed as shown in FIG. 14B. To select a desired item in the operation menu, the user is required to move the finger and enclose the item. FIG. 14B shows an example of enclosing the item “color” after enclosing the region to be edited.

If one item of the operation menu is enclosed in block B254, editing according to the selected item is executed in block B256. If the item “color” is selected, the color of characters is first changed to “red”. As in the process of FIG. 8, to change the color to another color, the user is required to continue the same operation (here, an enclosing operation). In block B258, it is determined whether the enclosing operation has been continued. If it is determined that the enclosing operation has been continued, it is determined whether the continued enclosing operation is clockwise in block B260. If the continued enclosing operation is clockwise, the process returns to block B256, and the color of the characters in the region to be edited is further changed. For example, the color is changed in the order of red, blue, green, yellow, red, and so on. If the continued enclosing operation is anticlockwise, the color is returned to the last color in block B262.

If it is determined that the enclosing operation has been stopped in block B258, it is determined whether an operation of enclosing another item (for example, type or thickness) is executed in block 8264. If the operation of enclosing the other item is executed, the process returns to block B256, and the similar changing process as describe above is executed for the other item.

The operation menu is displayed below the selected region to be edited in the example of FIG. 14B, but may be displayed in the remaining space such as a right side or an upper side if a display empty space does not exist below. Further, if the region to be edited is the entire display screen, the menu may be displayed near the center of the screen.

If the operation of enclosing another item is not executed in block B254, attribute data accompanying stroke data in the region to be edited is modified and stored in block B266.

In this manner, if a region including a character is enclosed with the finger after handwriting is input with the stylus, the operation menu including character edit items is displayed, and when an item is enclosed to select a process, a corresponding item is changed. The item can also be continuously changed by continuing the enclosing operation.

As in the character process, also in the table process of block B122, a menu for the table process is first displayed. Menu items include straightening a line, conversion of a handwritten character into text, coloring of a cell, etc. Moreover, also in the figure process of block B126, a menu for the figure process is first displayed. Menu items include display of a retrieval list, replacement with a retrieval result, etc.

In this manner, if a first-time first operation for one or more strokes is detected through the display, a menu for changing the display mode of the one or more first strokes from a first display mode to different second display modes is displayed. If any of the second display modes is selected on the menu following the first-time first operation, the display mode of the one or more first strokes is changed from the first display mode to a selected second display mode.

An item of the menu may be the undo/redo process. To add the undo/redo process to the menu is effective in the case where documents are closely written on the display and an empty region does not exist.

In the embodiment, those handwritten with the stylus are regarded as a document, and those handwritten with the finger are regarded as an instruction to execute an edit operation. However, even if input is performed with the stylus only, those handwritten in an edit mode may be regarded as an instruction to execute an edit operation by separately providing a menu for switching operation modes.

In the embodiment, although all the processes are executed in the tablet computer 10, processes other than handwriting on the touch screen display 17 may be executed on the server system 2. For example, a function of the processor 308 of the digital note application may be transferred to the server system 2. Moreover, the database of the server system 2 may be used for storage instead of the storage medium 402.

Because the processes of the embodiment can be achieved by a computer program, the same advantages as those obtained in the embodiment can be easily achieved by installing the computer program into a computer through a computer-readable storage medium storing the computer program and executing the computer program.

The present invention is not limited to the embodiments described above but the constituent elements of the invention can be modified in various manners without departing from the spirit and scope of the invention. Various aspects of the invention can also be extracted from any appropriate combination of a plurality of constituent elements disclosed in the embodiments. Some constituent elements may be deleted in all of the constituent elements disclosed in the embodiments. The constituent elements described in different embodiments may be combined arbitrarily.

What is claimed is:

1. An electronic apparatus comprising:
a display; and
circuitry configured to
receive stroke data corresponding to a handwritten stroke,
display a first stroke on the display,
change a display mode of the first stroke from a first display mode to a second display mode when a first-time first operation related to the first stroke is detected through the display, the second display mode different from the first display mode, and
change a display mode of the first stroke from the second display mode to a third display mode when a second-time first operation related to the first stroke is detected through the display following the first-time first operation, the third display mode different from both the first display mode and the second display mode,
wherein the first-time first operation and the second-time first operation are same.

2. The electronic apparatus of claim 1, wherein the circuitry is configured to change a display mode of the first stroke from the first display mode to the second display mode which is according to a type of the first stroke, when the first-time first operation related to the first stroke is detected though the display, and
the type of the first stroke comprises at least one of a character, a noncharacter, a figure, and a table.

3. The electronic apparatus of claim 1, wherein the circuitry is configured to change the first display mode to the second display mode by changing a first attribute of attributes of the first stroke, and change the second display mode to the third display mode by changing a second attribute of the attributes of the first stroke, and
the attributes of the first stroke comprise at least one of a thickness, a color and a type of a line.

4. The electronic apparatus of claim 1, wherein the first-time first operation and the second-time first operation comprise gesture operations of a same type which are executable on the display.

5. The electronic apparatus of claim 4, wherein the first-time first operation and the second-time first operation comprise operations of enclosing a region on the display, the region being at least a part of a display region of the first stroke on the display.

6. The electronic apparatus of claim 1, wherein the circuitry is configured to gradually change a display mode of the first stroke from the second display mode to the third display mode in accordance with an execution state of the second-time first operation during a period between a time at which the second-time first operation starts and a time at which the second-time first operation ends, when the second-time first operation related to the first stroke is detected though the display following the first-time first operation.

7. The electronic apparatus of claim 1, wherein the circuitry is configured to change a display mode of the first stroke from the second display mode to the first display mode, when a second operation related to the first stroke in an opposite direction to a direction of the first operation is detected through the display following the first-time first operation.

8. The electronic apparatus of claim 4, wherein the first-time first operation and the second-time first operation comprise at least one of tapping, double-tapping, flicking, sliding, swiping, spreading, pinching, and simultaneous tapping at points in a region on the display, the region being at least a part of a display region of the first stroke on the display.

9. The electronic apparatus of claim 1, wherein at least one of the changing from the first display mode to the second display mode and the changing from the second display mode to the third display mode executed by the circuitry comprises recognition of a character included in the first stroke, shaping of a line included in the first stokes, and coloring of a partial region of a table related to the first stroke, when a type of the first stroke is a table.

10. The electronic apparatus of claim 1, wherein the circuitry is configured to display a result of retrieval carried out using a character corresponding to the first stroke, when a type of the first stroke is a character and the first-time first operation or the second-time first operation is detected.

11. The electronic apparatus of claim 1, wherein, when a type of the first stroke is an image and a region specified by the first-time first operation or the second-time first operation includes a figure, the circuitry is configured to execute an image process for the figure.

12. The electronic apparatus of claim 1, wherein the circuitry is configured to:
display a menu for changing the display mode of the first stroke from the first display mode to second display modes, when the first-time first operation related to the first stroke is detected through the display; and
when one of the second display modes is selected on the menu following the first-time first operation, change a display mode of the first stroke from the first display mode to the selected second display mode.

13. A method for an electronic apparatus comprising a display, the method comprising:
inputting stroke data corresponding to a handwritten stroke;
displaying first stroke on the display;
changing a display mode of the first stroke from a first display mode to a second display mode when a first-time first operation related to the first stroke is detected through the display; and
changing the display mode of the first stroke from the second display mode to a third display mode when a second-time first operation related to the first stroke is detected through the display following the first-time first operation.

14. The method of claim 13, comprising:
changing the display mode of the first stroke from the first display mode to the second display mode which is according to a type of the first stroke, when the first-time first operation related to the first stroke is detected though the display, wherein the type of the first stroke comprises at least one of a character, a noncharacter, a figure, and a table.

15. The method of claim 13, comprising:
changing the first display mode to the second display mode by changing a first attribute of attributes of the first stroke, and change the second display mode to the third display mode by changing a second attribute of the attributes of the first stroke, wherein the attributes of the first stroke comprise at least one of a thickness, a color and a type of a line.

16. A non-transitory computer-readable storage medium having stored thereon a computer program which is executable by a computer, the computer program comprising instructions capable of causing the computer to execute functions of:
inputting stroke data corresponding to a handwritten stroke;
displaying first stroke on the display;
changing a display mode of the first stroke from a first display mode to a second display mode when a first-time first operation related to the first stroke is detected through the display; and
changing the display mode of the first stroke from the second display mode to a third display mode when a second-time first operation related to the first stroke is detected through the display following the first-time first operation.

17. The storage medium of claim 16, comprising:
changing the display mode of the first stroke from the first display mode to the second display mode which is according to a type of the first stroke, when the first-time first operation related to the first stroke is detected though the display, wherein the type of the first stroke comprises at least one of a character, a noncharacter, a figure, and a table.

18. The storage medium of claim 16, comprising:
changing the first display mode to the second display mode by changing a first attribute of attributes of the first stroke, and change the second display mode to the third display mode by changing a second attribute of the attributes of the first stroke, wherein the attributes of the first stroke comprise at least one of a thickness, a color and a type of a line.
